(19) United States
(12) Patent Application Publication
(10) Pub. No.: US 2020/0120709 A1
(43) Pub. Date: Apr. 16, 2020

(54) A Radio Network Node, a Wireless Device and Methods Therein for Handling of Random Access (RA) Messages

(71) Applicant: Telefonaktiebolaget LM Ericsson (publ), Stockholm (SE)

(72) Inventors: Gunnar Bergquist, Kista (SE); Jan Christoffersson, Luleå (SE); Mats Folke, Vällingby (SE); Riikka Susitaival, Helsinki (FI); Min Wang, Luleå (SE)

(21) Appl. No.: 16/463,427

(22) PCT Filed: Apr. 15, 2019
(86) PCT No.: PCT/SE2019/050344

§ 371 Date: May 23, 2019

Related U.S. Application Data
(60) Provisional application No. 62/668,831, filed on May 9, 2018.

(51) Int. Cl. H04W 74/00; H04W 74/08; H04W 74/02; H04W 72/14; H04W 76/11

(52) U.S. Cl. CPC H04W 74/008; H04W 74/0833; H04W 76/11; H04W 72/14; H04W 74/02

(57) ABSTRACT

A method performed by a wireless device (120) for transmitting a Random Access, RA, message to a radio network node (110). The wireless device and the radio network node operate in a wireless communications network (100). The wireless device determines a preamble from a group of preambles associated with an RA message size larger than the threshold value. This is done when the wireless device has a message to transmit that is larger than a threshold value. The wireless device transmits the determined preamble to the radio network node. Further, the wireless device receives, from the radio network node, an indication indicating that repetitions of transmission of an RA message are to be applied. Furthermore, the wireless device transmits, to the radio network node, the message in the RA message in accordance with the indication.

### TECHNICAL FIELD

Embodiments herein relate to a radio network node, a wireless device and to methods therein. Especially, embodiments relate to handling of Random Access (RA) messages.

### BACKGROUND

In a typical wireless communication network, wireless devices, also known as wireless communication devices, mobile stations, stations (STA) and/or User Equipments (UEs), communicate via a Local Area Network (LAN) such as a WiFi network or a Radio Access Network (RAN) to one or more Core Networks (CN). The RAN covers a geographical area which is divided into service areas or cell areas, which may also be referred to as a beam or a beam group, with each service area or cell area being served by a radio network node such as a radio access node e.g., a Wi-Fi access point or a Radio Base Station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

In addition to faster peak Internet connection speeds, 5G planning aims at higher capacity than current 4G, allowing higher number of mobile broadband users per area unit, and allowing consumption of higher or unlimited data quantities in gigabyte per month and user. This would make it feasible for a large portion of the population to stream high-definition media many hours per day with their mobile devices, when out of reach of W-Fi hotspots. 5G research and development also aims at improved support of machine to machine communication, also known as the Internet of things, aiming at lower cost, lower battery consumption and lower latency than 4G equipment.

New Radio (NR) Release 15 (Rel-15) is to be standardized. Besides higher carrier frequencies, many new radio techniques impacting on coverage performance are being introduced with NR. For example, new waveforms, frame structures, channel coding, and massive MIMO, etc. are being introduced with NR. However, the coverage performance of control channels and data channels for NR, both in split and stand-alone non-split bearer combinations with LTE, has not yet been well studied and addressed. Thus, further clarification of NR coverage performance is needed and enhancements will be necessary.

The NR communications networks are expected to perform on par with the LTE communications network even if deployed in the higher frequency spectra, e.g. above 6 GHz, for example at 28 GHz or even as high as 39 GHz. If radio coverage between a UE and a network node is not enough, more network nodes may need to be added to the communications network. The network nodes may be gNBs or nodes providing functions of gNBs. However, adding sites, e.g. network nodes, is costly and requires lengthy negotiations with building owners etc. Operators are not keen to add more sites, e.g. network nodes, as compared to the LTE communications networks in order to ensure sufficiently good coverage also for NR communications networks.

A random access procedure is used by e.g. idle UEs or inactive UEs who wish to connect to the communications network, e.g. to a network node such as a gNB, for data transmissions. The random access procedure is used also by connected UEs, e.g. by UEs being connected to the communications network, e.g. to the gNB, for various reasons such as beam failure recovery, hand over and regaining of UL synchronization. As illustrated in FIG. 1, a Contention Based Random Access (CBRA) procedure starts with a preamble selection and a transmission of the selected preamble, e.g. a selected RA preamble, from the UE to the network node, e.g. the gNB. This transmission may be referred to as a transmission of a message 1. The network node, e.g. the gNB, responds with a Random Access Response (RAR) transmitted to the UE. This transmission may be referred to as a transmission of a message 2. The RAR comprises a Temporary Cell Radio Network Temporary Identifier (C-RNTI), a Timing Advance (TA) value and a grant for the UE to send a message 3 Msg3 in the uplink (UL) e.g. to the network node. The message 3 may comprise information about the UE identity and a Buffer Status Report (BSR). The Msg3 is scheduled on the Physical Uplink Shared CHannel (PUSCH), as indicated by the grant received in the RAR. In many CBRA cases, the Msg3 carries an RRC message sent on the Common Control Channel (CCCH). The RRC message may be an RRC connection request, an RRC connection re-establishment request, or an RRC connection resume request message. The CCCH uses Transparent Mode in Radio Link Control (RLC TM).

RAR

A network node, e.g. the gNB, that momentarily detects more than one random access preamble may select to separate its responses in more than one Medium Access Control Physical Data Unit (MAC PDU), or it may select to concatenate its responses into one and the same MAC PDU, see FIG. 2 which illustrates an example of such a concatenated MAC PDU comprising MAC RARs. As illustrated in FIG. 2, a first MAC subPDU 1 comprises an E/T/R/R/BI subheader, wherein E refers to an extension bit, T refers to a type bit, R refers to a reserved bit, and BI is a Backoff Indicator. A second MAC subPDU 2 comprises an E/T/RAPID subheader. Further, an E/T/RAPID subheader is concatenated with the MAC RAR into a MAC subPDU 3. The acronym RAPID refers Random Access Preamble IDentity.

If the gNB cannot handle all detected preambles it may send a Backoff Indicator (BI) in response to certain preambles, as illustrated as MAC subPDU 1 in the leftmost part of FIG. 2. If the gNB detects a preamble that is used to request System Information (SI) it may just acknowledge reception, as illustrated as MAC subPDU 2 in FIG. 2.

The gNB may finally select to acknowledge a received preamble with a RAR and after this is where the Msg3 transmission occurs. The subheader corresponding to a RAR comprises three header fields E, T and RAPID illustrated as E/T/RAPID in FIG. 3. The E refers to an Extension bit, T refers to a type bit, and RAPID refers to six bits for the Random Access Preamble IDentity.

FIG. 4 exemplifies a MAC RAR. As schematically illustrated in FIG. 4, the MAC RAR comprises seven octets October 1-October 7, and each octet comprises eight bits. Apart from the field of reserved R bits, the payload corresponding to a RAR comprises three fields; the Timing Advance Command, the UL Grant and the Temporary C-RNTI, as 10 illustrated in FIG. 4. Particularly, the fields R and UL Grant are specified:
R: Reserved bit, set to “0”;
UL Grant: The Uplink Grant field indicates the resources to be used on the uplink in 3GPP TS 38.213. The size of the UL Grant field is 25 bits. As illustrated in FIG. 4, the UL Grant comprises the last bit in the second octet October 2 and then eight bits in each one of the third to fifth octets October 3-October 5.

UL Grant in the RAR

The UL grant in the RAR schedules a PUSCH transmission, e.g. a transmission of the message Msg3 on the PUSCH, from the UE to the network node. The contents of the RAR UL grant, starting with the Most Significant Bit (MSB) and ending with the Least Significant Bit (LSB), are given in Table 1 below.

TABLE 1
3GPP TS 38.213/Table 8.2-1: Random Access Response Grant Content
field size

| RAR grant field | Number of bits |
|---|---|
| Frequency hopping flag | 1 |
| Msg3 PUSCH frequency resource allocation | 12 |
| Msg3 PUSCH time resource allocation | 4 |
| MCS | 4 |
| TPC command for Msg3 PUSCH | 3 |
| CSI request | 1 |

Preamble Group Selection

Already during standardization of the LTE communications networks it was argued that it would be beneficial for certain use cases to separate the random access preambles into two groups. Now the standard document 3GPP TS 36.321 for the LTE 5 communications network specifies support for such preamble grouping. It is specified that, before the random access procedure is initiated, the following information pertaining to the preamble group selection is known by UE:
The parameters: numberOfRA-Preambles and sizeOfRA-PreamblesGroupA, that makes it possible to calculate which preambles are contained in Random Access Preambles group A and which are contained in Random Access Preambles group B. The preambles in Random Access Preamble group B are the preambles sizeOfRA-PreamblesGroupA to numberOfRA-Preambles—1 from a set of total 64 preambles;
The parameters messagePowerOffsetGroupB and messageSizeGroupA that shall be used to calculate the criteria required to select a preamble from Random Access Preambles group B:
For a CCCH Service Data Unit (SDU): the potential message size is greater than messageSizeGroupA;
Otherwise: the potential message size is greater than messageSizeGroupA and the pathloss is less than one based on threshold messagePowerOffsetGroupB.

### SUMMARY

As a part of developing embodiments herein a problem will first be identified and discussed.

The size of the message Msg3 in a NR communications network impacts the coverage of the NR communications network. To be more exact the size of the message Msg3 impacts the coverage of the PUSCH channel. By the term “coverage” when used in this disclosure is meant the radio coverage, i.e. a geographic area within which a communications device, e.g. a UE, is able to communicate with a network node, e.g. a gNB using a radio communications link. The message Msg3 is used when the UE requests establishment of a data transfer connection with the communications network, e.g. with a network node such as a gNB. The Msg3 is the first scheduled message that is being sent on the PUSCH from the UE to the network node, and therefore a small size of the message Msg3 is advantageous since the channel properties at this time are unknown.

The focus of the NR communications network has been on large data transfer, thus the message structures have been designed to fasten processing and to maximize throughput rather than saving overhead. On top of what is mentioned above, there are also concerns on how the physical layer structures of the NR communications network will impact coverage. As a result, an object is how to decrease the overhead in data structures used by the message Msg3 transmitted in the NR communications network.

However, an extended range of use cases in the NR communications network as compared to current LTE communications network may require larger sizes for the message Msg3 as compared to the current message Msg3 size in the LTE communications network. In other words, a larger size of the message Msg3 may be needed to support an extended range of use cases.

As the message Msg3 is the first message sent, the channel conditions for the PUSCH are not fully known and the Msg3 transmission requires a transfer as robust as possible. However, the Radio Link Control Transparent Mode (RLC TM) does not support segmentation, and thus the message Msg3 must be sent within a single transport block. Since the content and/or size of the message Msg3 is unknown to the gNB, the gNB must ensure that the grant is large enough to handle the possible Msg3 sizes. But at the same time, a larger size of the message Msg3 implies more information bits to send which in turn means less robust modulation and coding and less coverage.

Therefore, the NR communications network, and eventually the LTE communications network, will risk losing coverage also for the more basic use cases that does not need a larger Msg3 size.

An object of embodiments herein is therefore to improve the performance of a wireless communications network for handling of RA messages, e.g. for handling of the message Msg3.

According to an aspect of embodiments herein, the object is achieved by a method performed by a wireless device for transmitting a Random Access (RA) message to a radio network node. The wireless device and the radio network node operate in a wireless communications network.

When having a message to transmit that is larger than a threshold value, the wireless device determines a preamble from a group of preambles associated with an RA message size larger than the threshold value.

The wireless device transmits the determined preamble to the radio network node.

Further, the wireless device receives, from the radio network node, an indication indicating that repetitions of transmission of an RA message are to be applied.

Furthermore, the wireless device transmits, to the radio network node, the message in the RA message in accordance with the indication.

According to another aspect of embodiments herein, the object is achieved by a wireless device for transmitting a Random Access (RA) message to a radio network node. The wireless device and the radio network node are configured to operate in a wireless communications network.

The wireless device is configured to determine a preamble from a group of preambles associated with an RA message size larger than a threshold value, when having a message to transmit that is larger than the threshold value.

The wireless device is configured to transmit the determined preamble to the radio network node.

Further, the wireless device is configured to receive, from the radio network node, an indication indicating that repetitions of transmission of an RA message are to be applied.

Furthermore, the wireless device is configured to transmit, to the radio network node, the message in the RA message in accordance with the indication.

According to another aspect of embodiments herein, the object is achieved by a method performed by a radio network node for assisting a wireless device in transmission of a Random Access (RA) message to the radio network node. The radio network node and the wireless device operate in a wireless communications network.

The radio network node detects a preamble transmitted by the wireless device.

The radio network node determines that repetitions of transmission of an RA message are to be applied based on the detected preamble.

Further, the radio network node transmits, to the wireless device, an indication indicating that repetitions of transmission of the RA message are to be applied.

Furthermore, the radio network node receives the message in the RA message transmitted from wireless device in accordance with the indication.

According to another aspect of embodiments herein, the object is achieved a radio network node for assisting a wireless device in transmission of a Random Access (RA) message to the radio network node. The radio network node and the wireless device are configured to operate in a wireless communications network.

The radio network node is configured to detect a preamble transmitted by the wireless device.

The radio network node is configured to determine that repetitions of transmission of an RA message are to be applied based on the detected preamble.

Further, the radio network node is configured to transmit, to the wireless device, an indication indicating that repetitions of transmission of the RA message are to be applied.

Furthermore, the radio network node is configured to receive the message in the RA message transmitted from wireless device in accordance with the indication.

According to another aspect of embodiments herein, the object is achieved computer program comprises instructions, which when executed by at least one processor of the wireless device, cause the at least one processor of the wireless device to perform one or more of the actions described herein.

According to another aspect of embodiments herein, the object is achieved computer program comprises instructions, which when executed by at least one processor of the network node, cause the at least one processor of the network node to perform one or more of the actions described herein.

According to another aspect of embodiments herein, the object is achieved by a carrier, a computer program carrier, comprising the respective computer program, wherein the carrier is one of an electronic signal, an optical signal, an electromagnetic signal, a magnetic signal, an electric signal, a radio signal, a microwave signal, or a computer-readable storage medium.

Since the wireless device having a message to transmit that is larger than a threshold value determines a preamble from a group of preambles associated with an RA message size larger than the threshold value and since the wireless device transmits the message in repetitions the total energy used to transmit the message is increased, . This results in an improved performance of the wireless communications network.

### BRIEF DESCRIPTION OF THE DRAWINGS

Examples of embodiments herein are described in more detail with reference to attached drawings in which:

FIG. 1 is a schematic signaling scheme illustrating a Contention Based Random Access (CBRA) procedure;

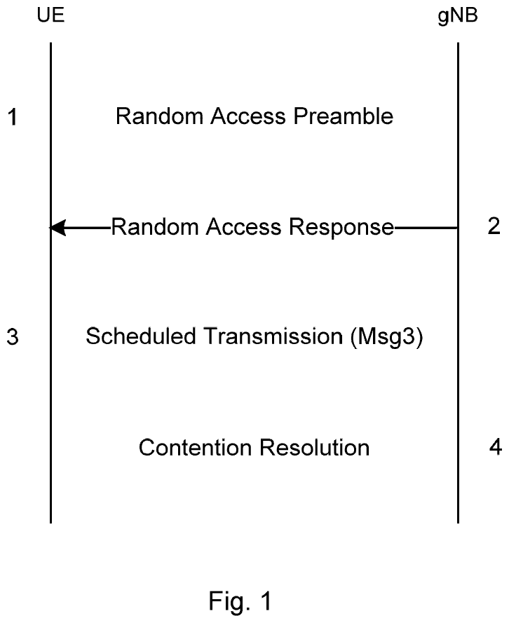

FIG. 2 is a schematic block diagram illustrating an example of a concatenated MAC PDU comprising MAC RAR;

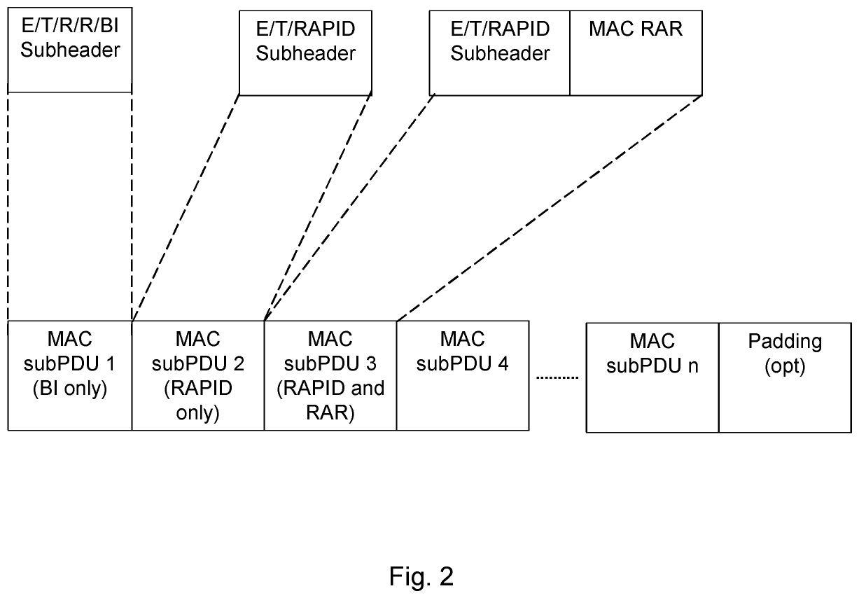

FIG. 3 is a schematic block diagram illustrating an example of a subheader corresponding to a RAR;

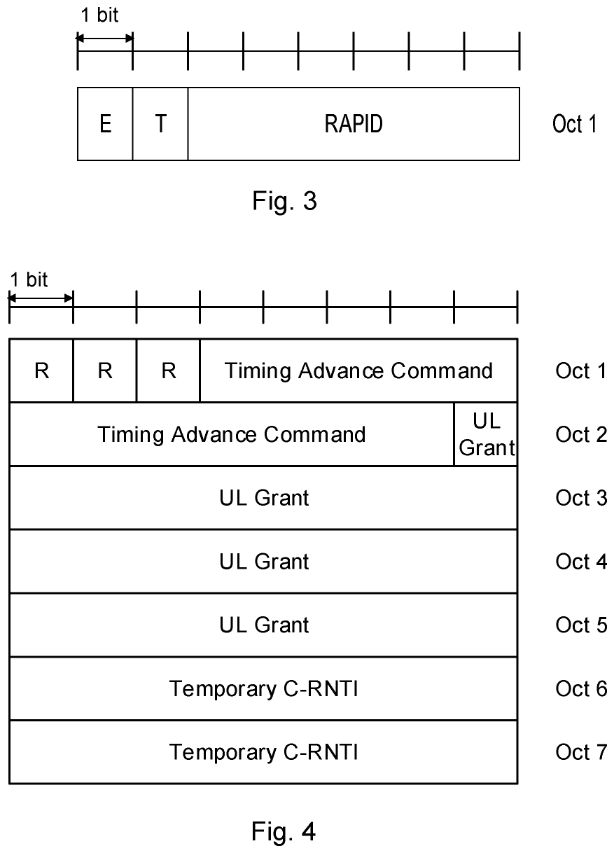

FIG. 4 is a schematic block diagram illustrating an example of a MAC RAR;

FIG. 5 is a schematic block diagram illustrating embodiments of a wireless communications network;

FIG. 6 is a flowchart depicting embodiments of methods in a wireless device;

FIG. 7 is schematic block diagram illustrating embodiments of a wireless device;

FIG. 8 is a flowchart depicting embodiments of a method in a radio network node;

FIG. 9 is schematic block diagram illustrating embodiments of a radio network node;

FIG. 10 is a schematic block diagram illustrating some first embodiments of a MAC RAR;

FIG. 11 is a schematic block diagram illustrating some second embodiments of a MAC RAR;

FIG. 12 schematically illustrates a telecommunication network connected via an intermediate network to a host computer;

FIG. 13 is a generalized block diagram of a host computer communicating via a base station with a user equipment over a partially wireless connection; and

FIGS. 14-17 are flowcharts illustrating methods implemented in a communication system including a host computer, a base station and a user equipment.

### DETAILED DESCRIPTION

Embodiments herein may refer to New Radio (NR), Random Access, coverage, MAC, Msg3, UL grant, repetition, slot aggregation, physical layer, adaptation and access layer.

In some embodiments disclosed herein, a preamble grouping with a conditional mapping to a RA message repetition, e.g. to a message Msg3 repetition, is used for those preambles, e.g. those special preambles, that are announced with one or more criteria which allow a larger message Msg3 size.

The number and type of resources for the Msg3 repetition may either be fixed by e.g. a standard specification, or broadcasted on the system information, or specifically configured and signaled to the UE(s) in the RAR.

The preamble group information, optionally along with any criteria thresholds associated to certain group(s), e.g. certain group(s) of preambles, is broadcasted on the system information. The criteria thresholds may be criteria threshold values.

The one or more criteria which allow the UE to select a preamble associated to a larger RA message size, e.g. a larger Msg3 size, and to repeated transmission(s) may either be fixed by a standard specification or broadcasted by system information, defined by a certain type of logical channel or group of logical channels, and/or optionally combined with a certain larger size of buffer mapped to the same logical channel or group of logical channels, and/or optionally combined with one or more threshold value(s) pertaining to the available transmission power and/or the attenuation of the propagation path.

Some advantages of embodiments disclosed herein are that they ensure that a smaller size of the RA message may be used for the legacy use cases, e.g. for the initial access to a gNB cell from an Idle Mode or for a handover into another gNB cell, which benefits from the immediate robust coverage it gives, and at same time a larger size of the RA message may be used for other use cases, e.g. for the case when resuming a suspended connection from the inactive state, with a larger information content which benefit from repetitions.

Coverage performance of the NR communications network will be on par with the present LTE communications networks. Thus, operators do not need to deploy a denser net of sites, e.g. a denser net of network nodes such as radio network nodes for example gNBs, as compared to that of the current LTE communications networks.

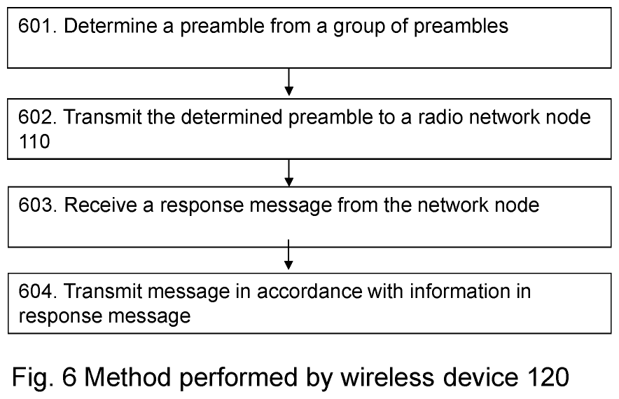

Embodiments herein relate to wireless communication networks in general. FIG. 5 is a schematic overview depicting a wireless communications network 100. The wireless communications network 100 may be referred to as a radio communications network. The wireless communications network 100 comprises one or more Radio Access Networks (RANs) and one or more Core Networks (CNs). The radio communications network 100 may use a number of different technologies, such as NB-IoT, CAT-M, Wi-Fi, eMTC, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Sometimes in this disclosure the wireless communications network 100 is referred to as just a network.

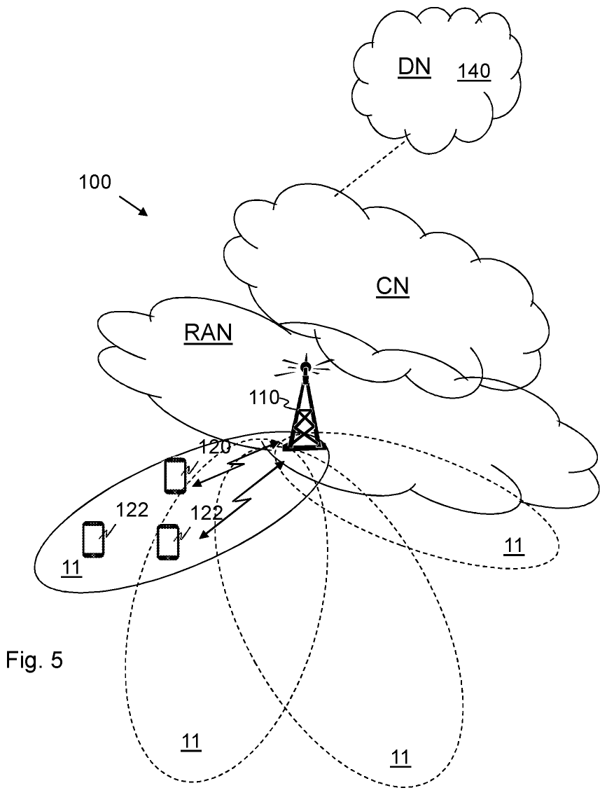

In the wireless communication network 100, wireless devices e.g. a wireless device 120 also referred to as the first UE 120, is operating in the wireless communications network 100. One or more further wireless devices 122 also referred to as one or more second UEs 122 may operate in the wireless communications network 100. As schematically illustrated in FIG. 4, the wireless device 120,122 may communicate with a network node, e.g. a network node 110 which will be described below.

The wireless devices 120, 122 may each e.g. be a mobile station, a non-Access Point (non-AP) STA, a STA, a user equipment and/or a wireless terminals, an NB-IoT device, an eMTC device and a CAT-M device, a WiFi device, an LTE device and an NR device communicating via one or more Access Networks (AN), e.g. RAN, to one or more Core Networks (CN). It should be understood by the skilled in the art that “wireless device” is a non-limiting term which means any terminal, communications device, wireless communication terminal, user equipment, Device to Device (D2D) terminal, or node e.g. smart phone, laptop, mobile phone, sensor, relay, mobile tablets or even a small base station communicating within a cell. Further, in this disclosure, the terms, e.g. the terms UE and wireless device, may be used interchangeably.

Network nodes operate in the radio communications network 100, such as a Radio Network Node (RNN) 110 also referred to as the first network node 110, providing radio coverage over a geographical area, a service area 11, which may also be referred to as a cell, a beam or a beam group of a first Radio Access Technology (RAT), such as 5G, LTE, Wi-Fi, NB-IoT, CAT-M, Wi-Fi, eMTC or similar. The network node 110 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by the network node 110 depending e.g. on the radio access technology and terminology used. The network node 110 may be referred to as a serving radio network node and communicates with the wireless device 120, 122 with Downlink (DL) transmissions to the wireless device 120, 122 and Uplink (UL) transmissions from the wireless device 120, 122.

Further, in this disclosure, the terms, e.g. the terms radio network node and gNB, may be used interchangeably.

Methods according to embodiments herein may be performed by any of the network node 110 such as e.g. a gNB, an eNB, and the wireless device 120, e.g. the UE, the mobility network node 130, the location server 132 and/or by the positioning server 134. As an alternative, a Distributed Node (DN) and functionality, e.g. comprised in a cloud 140 as shown in FIG. 5 may be used for performing or partly performing the methods.

Actions of Some Embodiments Herein

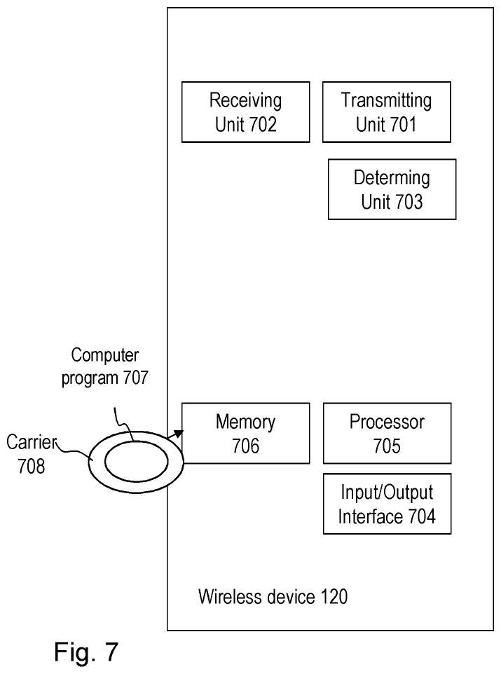

Example embodiments of a flowchart depicting embodiments of a method performed by the wireless device 120, e.g. to transmit a RA message such as a message Msg3, to the radio network node 110 is depicted in FIG. 6 and will be described more in detail in the following. As previously mentioned, the wireless device 120, e.g. the UE, and the radio network node 110, e.g. the gNB, operate in the wireless communications network 100. The method may comprise one or more of the following actions which actions may be taken in any suitable order. Further, it should be understood that one or more actions may be optional and that actions may be combined.

In Action 601, the wireless device 120 having a message or data to be transmitted which message or data is larger than a threshold value, determines a preamble from a group of preambles. The group of preambles may be the Random Access preamble Group B. As previously mentioned and as will be described in more detail below, the preamble is a preamble that allows for or is associated with a RA message size larger than a threshold value. Therefore, when having a message to transmit that is larger than a threshold value, the wireless device 120 determines a preamble from a group of preambles associated with an RA message size larger than the threshold value.

In some embodiments, the wireless device 120 determines the preamble from the group of preambles by performing at least one out of:
determining the preamble from a Random Access preamble Group B; and
determining the preamble from a group of contention-free random access preambles.

In Action 602, the wireless device 120 transmits the determined preamble to the radio network node 110. As mentioned above, the preamble is related to the message to be transmitted.

In Action 603, the wireless device 120 receives a response message, e.g. a RAR, from the radio network node 110. The response message is received in response to the transmitted preamble. The RAR comprises an indication indicating that repetitions of the message transmission are to be applied. The indication may indicate a number of repetitions to be made. In other words, the wireless device 120 receives, from the radio network node 110, an indication indicating that repetitions of transmission of an RA message are to be applied. Further, by the indication, the wireless device 120 will obtain information of the number of repetitions to be applied when transmitting the RA message. Thereby a sufficient coverage will be ensured.

Further, the indication may be received in a RAR message. In some embodiments, the indication is received in a broadcast signaling from the radio network node 110. This will be described in more detail below with reference to some third embodiments.

As will be described below with reference to some second embodiments, the RAR message comprises one reserved bit to encode an extra parameter in an uplink grant to enable repetitions of the RA message on a Physical Uplink Synchronization Channel (PUSCH).

In some embodiments, the indication comprises a number of repetitions of the RA message to be made. As will be described in more detail below, the repetitions of transmission of the RA message may be autonomous retransmissions of the RA message. By the expression “autonomous retransmission of the RA message” when used in this disclosure is meant that the UE performs multiple retransmissions autonomously in the time domain with the same grant resources in the frequency domain.

In Action 604, the wireless device 120 transmits, to the radio network node 110, the message in the RA message, e.g. the message Msg3, in accordance with the information in the response message, e.g. the RAR. In other words, the wireless device 120 transmits, to the radio network node 110, the message in the RA message in accordance with the indication. If for example, the RAR indicates two repetitions, the message Msg3 is transmitted twice. Thereby, twice as much information may be transmitted to the radio network node 110 or the coverage may be extended as compared to the case with no repetitions of the transmission.

Thus, the message is comprised in the RA message. In some embodiments wherein the message is comprised in the RA message, the RA message may also comprise uplink data, an RA message header and possibly other protocol control elements. However, it should be understood that the message may be the RA message.

The message Msg3 is the lower layer container, e.g. the MAC PDU, for the message or data. Thus, the Msg3 is all that fits into a given UL grant, all that the UE may have to send, according to priority rules where e.g. CCCH signaling data comes before DCCH signaling data, which in turn comes before DTCH user plane data etc.

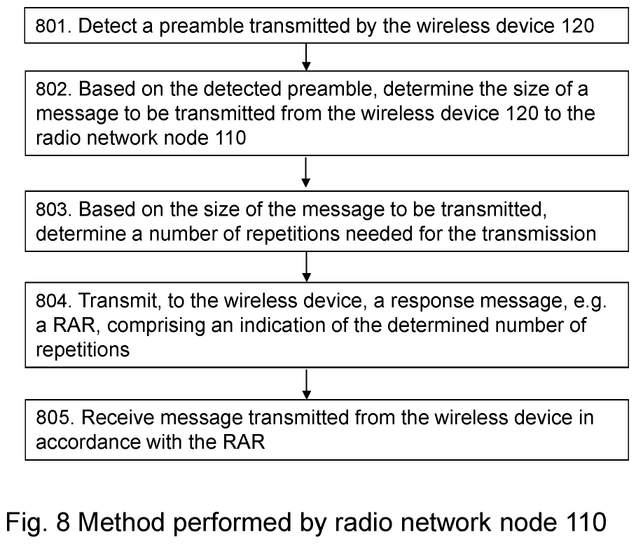

To perform the method actions e.g. to transmit a RA message such as a message Msg3, the wireless device 120 may comprise the arrangement depicted in FIG. 7. The wireless device 120 may e.g. comprise a transmitting unit 701, a receiving unit 702, and a determining unit 703. As previously mentioned, the wireless device 120 and the radio network node 110 are configured to operate in the wireless communications network 100.

The wireless device 120 is configured to transmit, e.g. by means of the transmitting unit 701, a signal, message or information to one or more nodes operating in the communications network 100. The transmitting unit 701 may be implemented by or arranged in communication with a processor 705 of the wireless device 120. The processor 705 will be described in more detail below.

The wireless device 120 is configured to transmit a determined preamble to the radio network node 110.

Further, the wireless device 120 is configured to transmit, to the radio network node 110, the message in the RA message in accordance with the indication.

The wireless device 120 is configured to receive, e.g. by means of the receiving unit 702, a signal, message or information from one or more nodes operating in the communications network 100. The receiving unit 702 may be implemented by or arranged in communication with the processor 705.

The wireless device 120 is configured to receive, from the radio network node 110, an indication indicating that repetitions of transmission of an RA message are to be applied.

As previously mentioned, the indication may be received in a RAR message. In some embodiments, the indication is received in a broadcast signaling from the radio network node 110.

As will be described below with reference to some second embodiments, the RAR message comprises one reserved bit to encode an extra parameter in an uplink grant to enable repetitions of the RA message on a Physical Uplink Synchronization Channel (PUSCH).

In some embodiments, the indication comprises a number of repetitions of the RA message to be made. As will be described in more detail below, the repetitions of transmission of the RA message may be autonomous retransmissions of the RA message.

The wireless device 120 may be configured to determine, e.g. by means of the determining unit 703, a preamble. The determining unit 703 may be implemented by or arranged in communication with the processor 705.

In some embodiments, the wireless device 120 is configured to determine a preamble from a group of preambles associated with an RA message size larger than a threshold value. This may be the case when the wireless device 120 has a message to transmit that is larger than a threshold value.

The wireless device 120 may be configured to determine the preamble from the group of preambles by performing at least one out of:
determining the preamble from a Random Access preamble Group B; and
determining the preamble from a group of contention-free random access preambles.

Those skilled in the art will also appreciate that the units in the wireless device 120, described above may refer to a combination of analog and digital circuits, and/or one or more processors configured with software and/or firmware, e.g. stored in the wireless device 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

The wireless device 120 may comprise an input and output interface 704 configured to communicate with the network node 110 and the location server 132. The input and output interface may comprise a wireless receiver (not shown) and a wireless transmitter (not shown).

The embodiments herein may be implemented through a respective processor or one or more processors, such as the processor 705 of a processing circuitry in wireless device 120 depicted in FIG. 7, together with respective computer program code for performing the functions and actions of the embodiments herein. The program code mentioned above may also be provided as a computer program product, for instance in the form of a data carrier carrying computer program code for performing the embodiments herein when being loaded into the wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise a memory 706 comprising one or more memory units. The memory comprises instructions executable by the processor in the wireless device 120.

The memory is arranged to be used to store e.g. data, configurations, and applications to perform the methods herein when being executed in the wireless device 120.

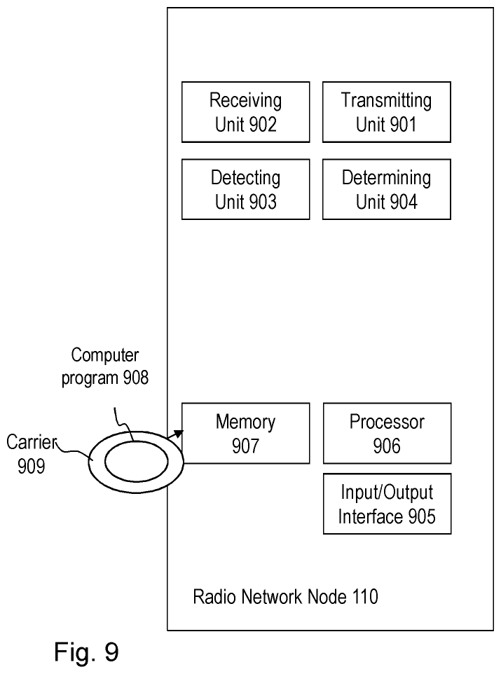

Example embodiments of a flowchart depicting embodiments of a method performed by the radio network node 110, e.g. the gNB, to assist the wireless device 120 in transmission of RA messages, such as a Msg3, to the radio network node 110 is depicted in FIG. 8 and will be described more in detail in the following. The method may comprise one or more of the following actions which actions may be taken in any suitable order. Further, it should be understood that one or more actions may be optional and that actions may be combined. As previously mentioned, the radio network node 110 and the wireless device 120 operate in the wireless communications network 100.

In Action 801, the RNN 110 detects a preamble transmitted by the wireless device 120. The detected preamble may be a preamble from at least one out of:

a Random Access preamble Group B; and

a group of contention-free random access preambles.

In Action 802, based on the detected preamble, the RNN 110 determines the size of a message to be transmitted from the wireless device 120 to the radio network node 110. Thus, in some embodiments, the radio network node 110 determines a size of a message to be transmitted from the wireless device 120 to the radio network node 110 based on the detected preamble.

In Action 803, based on the detected preamble or the determined size of the message to be transmitted by the wireless device 120, the radio network node 110 determines a number of repetitions needed for the transmission, i.e. the transmission of an RA message. In other words, based on the detected preamble, the radio network node 110 determines that repetitions of transmission of the RA message are to be applied.

In some embodiments, wherein the radio network node 110 has determined the size of the message to be transmitted from the wireless device 120 based on the detected preamble, the radio network node 100 may determine a number of repetitions needed for transmission of the RA message based on the determined size of the message.

In Action 804, the radio network node 110 transmits a response message, e.g. a RAR, to the wireless device 120. The response message comprises an indication indicating that repetitions are to be applied. In other words, the radio network node 110 transmits, to the wireless device 120, an indication indicating that repetitions of transmission of the RA message are to be applied. The indication may indicate the determined number of repetitions the wireless device 120 should apply for the transmission of the message. Thus, the indication may comprise a number of repetitions of the RA message to be made. Further, the RAR may comprise information relating to radio resources to be used by the wireless device 120 for the transmission and to scheduling information.

In some embodiments, for example in some second embodiments as will be described in more detail below, the RAR message comprises one reserved bit to encode an extra parameter in an uplink grant to enable repetitions of the RA message on a Physical Uplink Synchronization Channel (PUSCH).

In some embodiments, for example in some third embodiments as will be described in more detail below, the radio network node 110 transmits the indication in a broadcast signaling to the wireless device 120.

In some embodiments, the repetitions of transmission of the RA message are autonomous retransmissions of the RA message.

In Action 805 the radio network node 110 receives the RA message, e.g. the Msg3, transmitted from wireless device 120 in accordance with the response message. Thus, the radio network node 110 receives the message in the RA message transmitted from wireless device 120 in accordance with the indication.

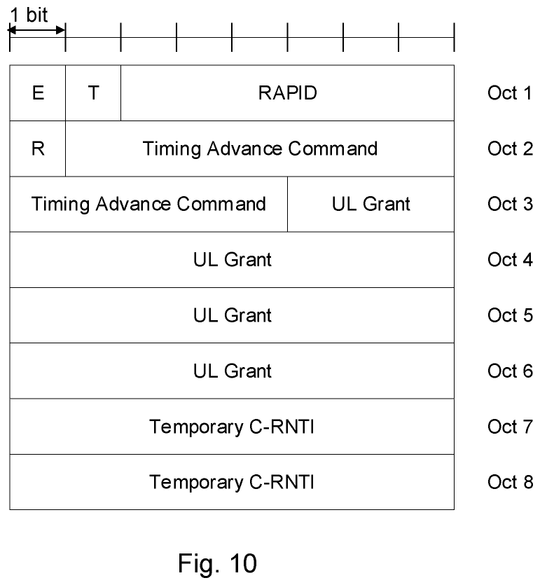

To perform the method actions e.g. for assisting the wireless device 120 in transmission of RA messages, such as a Msg3, to the radio network node, the radio network node 110 may comprise the arrangement depicted in FIG. 9. The radio network node 110 may e.g. comprise a transmitting unit 901, a receiving unit 902, a detecting unit 903, and a determining unit 904. As previously mentioned, the wireless device 120 and the radio network node 110 are configured to operate in the wireless communications network 100.

The radio network node 110 is configured to transmit, e.g. by means of the transmitting unit 901, a signal, message or information to one or more nodes operating in the communications network 100. The transmitting unit 901 may be implemented by or arranged in communication with a processor 906 of the radio network node 110. The processor 906 will be described in more detail below.

In some embodiments, the radio network node 120 is configured to transmit, to the wireless device 120, an indication indicating that repetitions of transmission of the RA message are to be applied. The indication may comprise a number of repetitions of the RA message to be made.

The radio network node 110 may be configured to transmit the indication to the wireless device 120 by further being configured to transmit a RAR message comprising the indication.

In some embodiments, for example as in some second embodiments, the RAR message comprises one reserved bit to encode an extra parameter in an uplink grant to enable repetitions of the RA message on a PUSCH.

In some embodiments, for example as in some third embodiments, the radio network node 110 is configured to transmit the indication to the wireless device 120 by further being configured to transmit the indication in a broadcast signaling to the wireless device 120.

As previously mentioned, the repetitions of transmission of the RA message may be autonomous retransmissions of the RA message.

The radio network node 110 is configured to receive, e.g. by means of the receiving unit 902, a signal, message or information from one or more nodes operating in the communications network 100. The receiving unit 902 may be implemented by or arranged in communication with the processor 906.

In some embodiments, the radio network node 110 receives a message transmitted from the wireless device 120 in the RA message transmitted from wireless device 120 in accordance with the indication.

The radio network node 110 is configured to detect, e.g. by means of the detecting unit 903, a preamble transmitted by the wireless device 120. The detecting unit 903 may be implemented by or arranged in communication with the processor 906.

In some embodiments, the detected preamble is a preamble from at least one out of: a Random Access preamble Group B; and a group of contention-free random access preambles.

The radio network node 110 is configured to determine, e.g. by means of the determining unit 904, based on the detected preamble, that repetitions of transmission of an RA message are to be applied. The determining unit 904 may be implemented by or arranged in communication with the processor 906.

In some embodiments, the radio network node 110 is configured to determine, based on the detected preamble, a size of a message to be transmitted from the wireless device 120 to the radio network node 110. The radio network node 110 may further be configured to determine a number of repetitions needed for transmission of the RA message based on the determined size of the message.

Those skilled in the art will also appreciate that the units in the radio network node 110 described above may refer to a combination of analog and digital circuits, and/or one or more processors configured with software and/or firmware, e.g. stored in the network node 110 that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

The radio network node 110 may comprise an input and output interface 905 configured to communicate with one or more out of the wireless device 120, 122, the network node 130, and the location server 132. The input and output interface may comprise a wireless receiver (not shown) and a wireless transmitter (not shown).

The embodiments herein may be implemented through a respective processor or one or more processors, such as the processor 906 of a processing circuitry in network node 110 depicted in FIG. 9, together with respective computer program code for performing functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 907 comprising one or more memory units. The memory comprises instructions executable by the processor in the network node 110.

The memory is arranged to be used to store e.g. data, configurations, and applications to perform the methods herein when being executed in the network node 110. For example, the memory may comprise the buffer having the buffer size referred to herein.

In some embodiments, a respective computer program 908 comprises instructions, which when executed by the respective at least one processor, cause the at least one processor of the network node 110 to perform one or more of the actions described herein.

In some embodiments, a respective computer program 707 comprises instructions, which when executed by the respective at least one processor, cause the at least one processor of the wireless device 120 to perform the actions described herein.

In some embodiments, a respective carrier 909, 708 comprises the respective computer program, wherein the carrier is one of an electronic signal, an optical signal, an electromagnetic signal, a magnetic signal, an electric signal, a radio signal, a microwave signal, or a computer-readable storage medium.

Below a More Detailed Description will Follow.

The embodiments described below relate to one or more of the actions described above.

### Some First Embodiments

In some first embodiments, two reserved bits R is allocated. One R bit occurs in the RAR payload, and another R bit is to reuse an existing field. In one example, the CSI request bit may be reused in the UL grant field. In case the associated RA is a contention based random access procedure, the CSI request bit is reserved and used to encode an extra parameter in the UL grant to configure a number of repetitions, e.g. 1, 2, 4 or 8 repetitions.

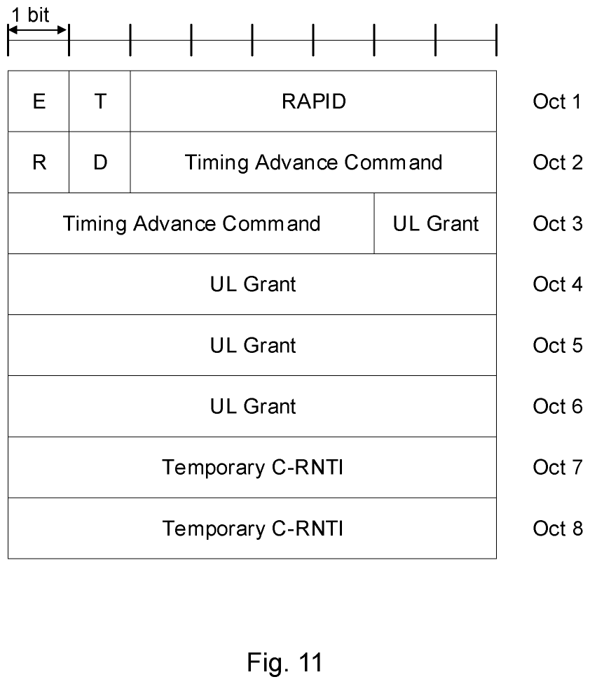

FIG. 10 schematically illustrates some first embodiments of a MAC RAR. One benefit of this approach is that it uses the same coding as is used for slot aggregation in connected mode. In FIG. 4 the uplink grant comprises 25 bit and as in FIG. 10 the uplink grant of some first embodiments has been extended to comprise 27 bits. If one of the bits in the field, i.e. one of the bits in the extended UL grant in FIG. 10, is set to 1, the legacy case without repetitions is contained. If one of the bits in the field, i.e. in the UL grant, is set to 2, the initial transmission of the Msg3 is quickly repeated two times, if one of the bits in the field, i.e. in the UL grant, is set to 4, the Msg3 transmission is repeated four times, and so on. Normal stop-and-wait Hybrid Automatic Repeat Request (HARQ), i.e. with the Physical Downlink Control Channel (PDCCH) grant, may be used for subsequent adaptive retransmissions of the Msg3.

In FIG. 10, R is the Reserved bit field, set to “0”, and the UL Grant is the Uplink Grant field indicating the resources to be used on the uplink. It should be understood that the R bits are always set to 0. In legacy there were three such bits, cf. the 3 R bits of FIG. 4. In FIG. 10, only one R bit remains. The other two has transferred as being bits of the UL grant field. The size of the UL Grant field in this example embodiment is 27 bits instead of 25 in the legacy case, cf. FIG. 4.

### Some Second Embodiments

In some second embodiments, one of the two reserved R bits is allocated. One R bit occurs in the RAR payload, and another R bit is to reuse an existing field. As previously mentioned, in one example, the CSI request bit may be reused in the UL grant field. In case the associated RA is a contention based random access procedure, the CSI request bit is reserved and used to encode an extra parameter in the UL grant to enable Physical Uplink Synchronization Channel (PUSCH) repetition, i.e. repetitions of the Msg3 on the PUSCH.

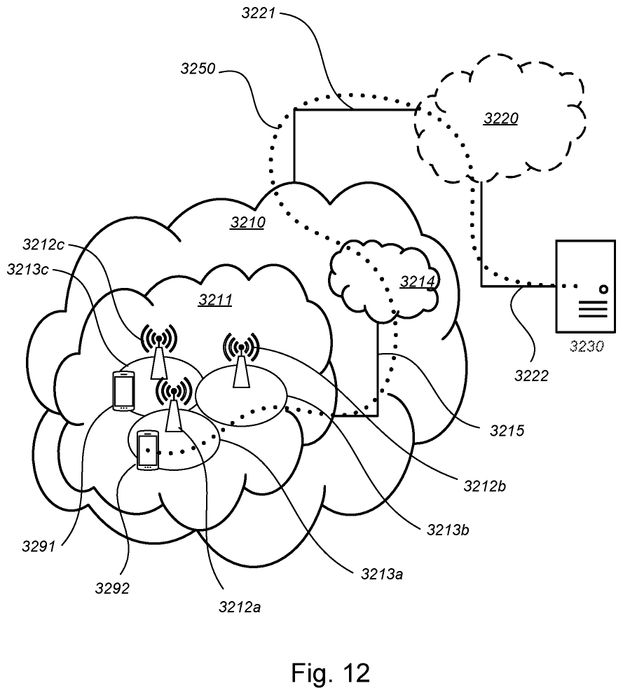

FIG. 11 schematically illustrates some second embodiments of a MAC RAR. As illustrated, in FIG. 10 the uplink grant of some second embodiments has been extended to comprise one extra bit as compared to the legacy case shown in FIG. 4. In some second embodiments, the uplink grant comprises 26 bits instead of the legacy 25 bits. If the bit is set to 1, the initial transmission of the Msg3 is repeated, e.g. two times over separate PUSCH time and/or frequency resources, or as on many resources (e.g. as many times) as may be configured by broadcasted system information for such repetition or slot aggregation. Thus, in some second embodiments, the bit(s) in the UL grant just enables and indicates retransmission and is/are not used to indicate or specify the number repetitions as in some first embodiments described above. In some second embodiments, yet another one of the reserved R bits is allocated and used to encode a new field in the RAR itself. The field is used to enable a quick repeat of each subsequent HARQ retransmission of the Msg3. If the bit is set to 1, each adaptive retransmission of the Msg3 is repeated, e.g. two times over separate PUSCH time and/or frequency resources, or as on many resources (e.g. as many times) as have been configured by broadcasted system information for such repetition or slot aggregation. The broadcasted system information may be defined by a pusch-AggregationFactor-Msg3 in the RRC IE RACH ConfigCommon. Thus, a repetition value is configured in the new SI IE, and if the R bit is set, the configured value is used as number of repetitions.

In FIG. 11, R is the Reserved bit, set to “0”; D is the duplication field indicates whether or not repetitions apply to adaptive retransmissions; and UL Grant is the Uplink Grant field indicating the resources to be used on the uplink. The size of the UL Grant field in this example embodiment is 26 bits.

### Some Third Embodiments

In some third embodiments, the repetitions are realized by a configuration in the system information alone, e.g. within the RRC IE RACH ConfigCommon that appears in System Information Block type 1 (SIB1). The configuration may comprise the exact number of repetitions or the configuration may be an indicator to use the same number of repetitions as is configured for the PUSCH aggregation.

In some embodiments, if a broadcast signaling indicates that repetitions are used, all UEs, e.g. the wireless device 120, repeat all Msg3 transmission. In some alternative embodiments, e.g. as in some second embodiments described above, the network, e.g. the radio network node 110, indicates in the broadcast signaling the amount of repetitions, here referred to as N. Then, if the bit in the RAR is set to 1 and thus indicates that repetition is enabled, the UE repeats the Msg3 transmission N times.

In each of some first to third embodiments described above, a Msg3 repetition may be coupled, e.g. associated, to certain random access preambles and/or random access resources. Such certain preambles and/or resources may be either:
Random Access Preambles group B (3GPP TS 38.321); or
Contention-Free Random Access (CFRA) Preambles/Resources (3GPP TS 38.321).

In some of the third embodiments above, a Msg3 repetition may furthermore be coupled, e.g. associated, to the size of the UL grant, i.e. the Msg3 repetition is applicable if the UL grant is larger than a threshold, e.g. a threshold value, or to any other parameter in the UL grant. That is, if the size of the Msg3 is larger than a threshold, the Msg3 is repeated N times. The parameter N may be broadcasted by the network, e.g. by the radio network node 110, signaled in RAR or it may be fixed.

In some embodiments, the Msg3 is repeated N times if the preamble group B is selected by the UE, e.g. the wireless device 120. In the current standard, the UE selects preamble B if the size of the Msg3 exceeds a threshold value and/or if the pathloss is under another threshold value. Having repetitions associated with preamble group B allows omission of the pathloss threshold value or to set it to a high value (as repetitions provide additional coverage).

In some embodiments, a separate preamble group or partition is allocated to the UE, e.g. wireless device 120, when it is operating within an area with bad coverage. If the pathloss measured by the UE is under a threshold value X, then the UE selects a preamble from a certain preamble group or partition. Based on the selected preamble, the network, e.g. the radio network node 110 such as the gNB, may schedule Msg3 with repetition. The number N of repetitions may be indicated to the wireless device 120 in RAR or it may be fixed in the standard. For example, the Msg3 is always repeated if the UE selected a preamble associated with the poor coverage.

Repeated Msg3 Transmissions

As described above, the coverage may be increased by the use of Msg3 repetitions, e.g. autonomous Msg3 retransmissions.

However, introducing Msg3 repetitions for increased coverage may introduce additional latency and increase PUSCH resource consumption compared to single Msg3 transmission. Having the possibility to transmit 56 bit messages without repetitions would therefore still be advantageous, i.e. Msg3 repetitions should only be used in case of larger grants.

It should be understood that the Msg3 repetitions may be signaled in different ways. One way is to include it in SIB1. This would be simple but not have enough granularity. As mentioned above, introducing autonomous repetitions for all Msg3 transmissions would make the 56 bit grants to suffer from increased PUSCH resource consumption and extra latency compared to if single transmission is used. Another way is to configure it in SIB1 but only applying it for Msg3 size above a threshold, e.g. when Random Access preamble group B is used or if e.g. the grant is above a threshold. However, in order to have full flexibility for using Msg3 repetitions, an indication should be carried in the RAR message utilizing e.g. some of the reserved bits. This would enable the gNB to configure the repetitions on a need basis, e.g. depending on grant size, cell load and deployment.

Observation: Indicating number of repetitions in RAR would allow high granularity to differentiate the number of repetitions depending on grant size, cell load and deployment.

Proposal: Indicate the number of autonomous Msg3 retransmissions in the RAR message.

Indicating Needed Grant Size

Since the reason for the random access is unknown to the gNB, i.e. the radio network node 110, the needed size of the grant is also unknown to the gNB. Of course, the gNB could always give a large enough grant to fit all possible Msg3 and use a high number of repetitions. This approach may be wasteful regarding PDCCH and PUSCH resources and latency.

An option to handle grant assignment is to use a minimum grant for CBRA using random access preamble group A, i.e., setting the ra-Msg3SizeGroupA to the size of the smallest RRC messages (e.g 56 bits). If the UE wishes to transmit a Msg3 larger than this, it selects the random access preamble group B which informs the gNB to reply with a larger grant. Random access preamble group B may then handle cases requiring a larger grant such as the RRC Resume Request.

According to 38.321, using Preamble group B also requires that the pathloss is low enough or that the messagePowerOffsetGroupB is configured to handle the larger Msg3 sizes irrespective of pathloss. This may be achieved by configuring it to minus infinity.

Observation: The parameter messagePowerOffsetGroupB may be configured such that the selection between preamble group A or B is only determined based on the size of RRC message which helps the gNB to select a suitable grant for msg3.

Some embodiments described herein relate to an alternative solution. The alternative solution is to allow selection of random access preamble group B ignoring the pathloss for CCCH transmissions as in LTE. This may allow the pathloss to be considered for Random Access preamble group B when Msg3 is not a CCCH transmission.

Proposal: Allow selection of random access preamble group B without considering pathloss for CCCH transmissions.

Using the random access preamble group B to indicate a need for a larger Msg will also implicitly indicate the need for repetitions. Random access preamble group A may then be used for the minimum grant of 56 bits and typically use no repetitions. The random access preamble group B may then be used for larger Msg3, e.g. for RRC Resume with repetitions and typically have repetitions. Depending on the grant size (72 bits or more), the gNB would indicate the number of repetitions in the RAR to ensure sufficient coverage. This approach will enable a high degree of flexibility to ensure both low latency for minimum size grants and ensure coverage for larger grants.

Observation: Using random access preamble group A for minimum grant size and random access preamble group B together with indication of repetitions in RAR will ensure low latency for minimum size grants and sufficient coverage for larger grants.

Further Extensions and Variations

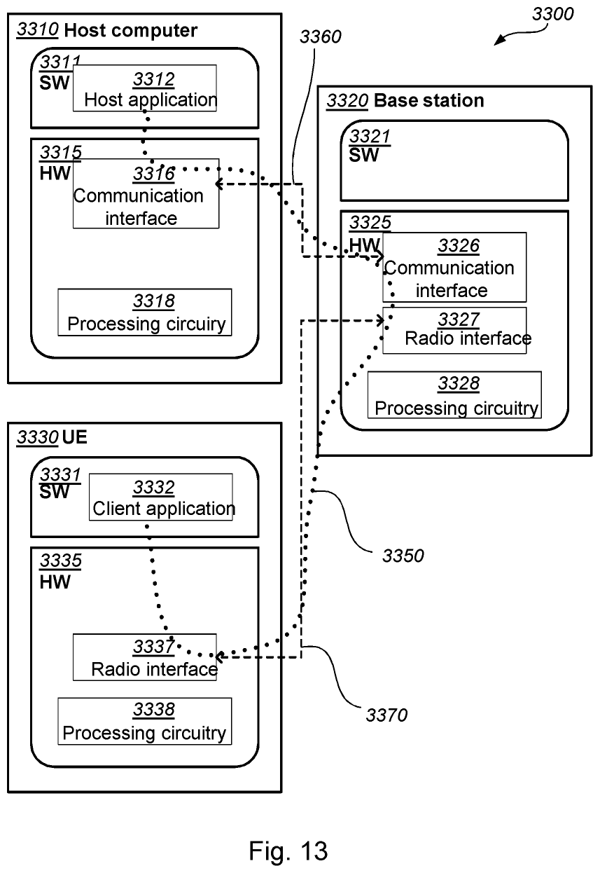

With reference to FIG. 12, in accordance with an embodiment, a communication system includes a telecommunication network 3210 such as the wireless communications network 100, e.g. a WLAN, such as a 3GPP-type cellular network, which comprises an access network 3211, such as a radio access network, and a core network 3214. The access network 3211 comprises a plurality of base stations 3212a, 3212b, 3212c, such as the network node 110, 130, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

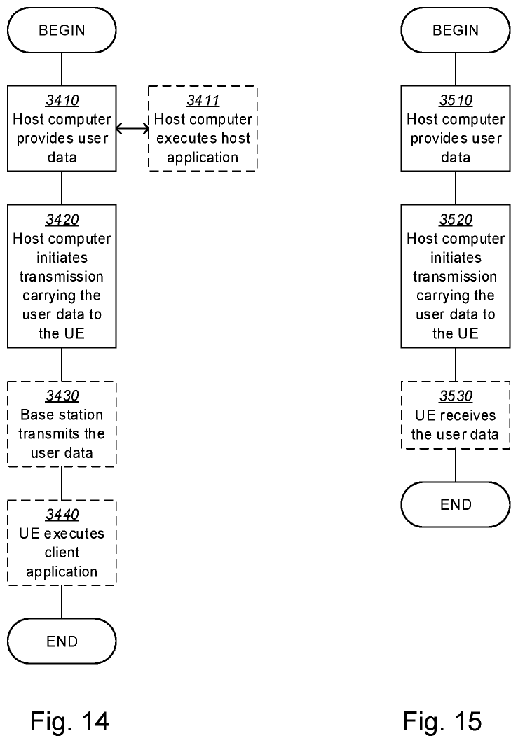

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 19) served by the base station 3320. The communication interface 3326 may be configured to facilitate a connection 3360 to the host computer 3310. The connection 3360 may be direct or it may pass through a core network (not shown in FIG. 19) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the coverage and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

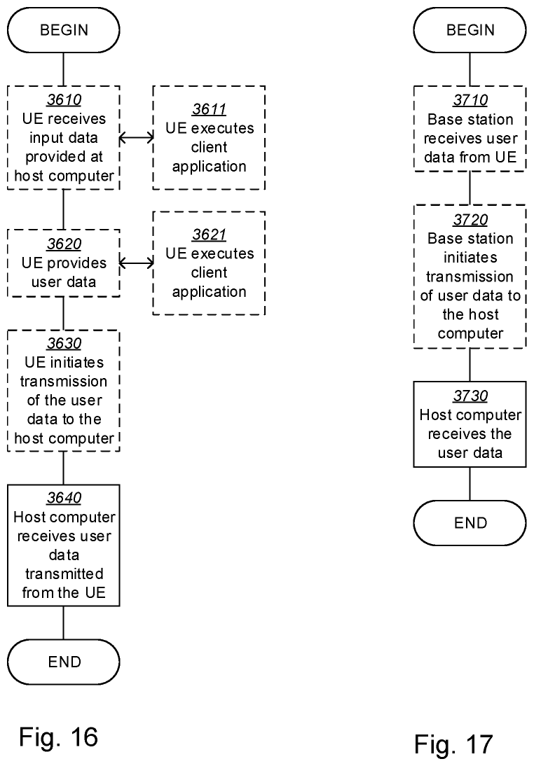

FIGS. 12 and 13 and the corresponding text are about a downstream aspect of the radio-related invention, while FIGS. 14 and 15 and the corresponding text discuss an upstream aspect.

FIG. 14 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 14 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 15 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

FIG. 16 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 16 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 17 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATION EXPLANATION

ARQ Automatic Repeat Request

CCCH Common Control Channel

CE Control Element

CCCH Common Control Channel

CE Control Element

C-RNTI Cell Radio Network Temporary Identifier

CSI Channel State Information

DCI Dedicated Control Information

HARQ Hybrid ARQ

MCS Modulation and Coding Scheme

NR New Radio

PDU Protocol Data Unit

PUSCH Physical UL Shared Channel

RACH Random Access Channel

RAPID Random Access Preamble Identifier

RAR Random Access Response

RRC Radio Resource Control

SDU Service Data Unit

SI System Information

TAC Timing Advance Command

TPC Transmit Power Control

UL Uplink

1-36. (canceled)

37. A method performed by a wireless device for transmitting a Random Access, RA, message to a radio network node, wherein the wireless device and the radio network node operate in a wireless communications network, and wherein the method comprises:
when having a message to transmit that is larger than a threshold value, determining a preamble from a group of preambles associated with an RA message size larger than the threshold value;
transmitting the determined preamble to the radio network node;
receiving, from the radio network node, an indication indicating that repetitions of transmission of an RA message are to be applied; and
transmitting, to the radio network node, the message in the RA message in accordance with the indication.

38. The method of claim 37, wherein the determining of the preamble from a group of preambles comprises at least one out of:
determining the preamble from a Random Access preamble Group B; and
determining the preamble from a group of contention-free random access preambles.

39. The method of claim 37, wherein the indication is received in a Random Access Response, RAR, message or in a broadcast signaling from the radio network node.

40. The method of claim 37, wherein the indication is received in a Random Access Response, RAR, message, and wherein the RAR message comprises one reserved bit to encode an extra parameter in an uplink grant to enable repetitions of the RA message on a Physical Uplink Synchronization Channel, PUSCH.

41. The method of claim 37, wherein the RA message is a message Msg3.

42. The method of claim 37, wherein the indication comprises a number of repetitions of the RA message to be made.

43. A method performed by a radio network node for assisting a wireless device in transmission of a Random Access, RA, message to the radio network node, wherein the radio network node and the wireless device operate in a wireless communications network, and wherein the method comprises:
detecting a preamble transmitted by the wireless device;
based on the detected preamble, determining that repetitions of transmission of an RA message are to be applied;
transmitting, to the wireless device, an indication indicating that repetitions of transmission of the RA message are to be applied; and
receiving a message in the RA message transmitted from wireless device in accordance with the indication.

44. The method of claim 43, further comprising, based on the detected preamble, determining a size of the message to be transmitted from the wireless device to the radio network node, and wherein the determining that repetitions of transmission of the RA message are to be applied further comprises determining a number of repetitions needed for transmission of the RA message based on the determined size of the message.

45. The method of claim 43, wherein the RA message is a message Msg3, wherein the indication comprises a number of repetitions of the RA message to be made, and wherein the transmitting of the indication to the wireless device comprises either:
transmitting a Random Access Response, RAR, message comprising the indication; or
transmitting the indication in a broadcast signaling to the wireless device.

46. A wireless device for transmitting a Random Access, RA, message to a radio network node, wherein the wireless device and the radio network node are configured to operate in a wireless communications network, and wherein the wireless device comprises processing circuitry configured to:
determine a preamble from a group of preambles associated with an RA message size larger than a threshold value, when having a message to transmit that is larger than the threshold value;
transmit the determined preamble to the radio network node;
receive, from the radio network node, an indication indicating that repetitions of transmission of an RA message are to be applied; and
transmit, to the radio network node, the message in the RA message in accordance with the indication.

47. The wireless device of claim 46, wherein the processing circuitry is configured to determine the preamble from a group of preambles by further being configured to perform at least one out of:
determining the preamble from a Random Access preamble Group B; and
determining the preamble from a group of contention-free random access preambles.

48. The wireless device of claim 46, wherein the indication is received in a Random Access Response, RAR, message.

49. The wireless device of claim 48, wherein the RAR message comprises one reserved bit to encode an extra parameter in an uplink grant to enable repetitions of the RA message on a Physical Uplink Synchronization Channel, PUSCH.

50. The wireless device of claim 46, wherein the indication is received in a broadcast signaling from the radio network node.

51. The wireless device of claim 46, wherein the RA message is a message Msg3.

52. The wireless device of claim 46, wherein the indication comprises a number of repetitions of the RA message be made.

53. The wireless device of claim 46, wherein the repetitions of transmission of the RA message are autonomous retransmissions of the RA message.

54. A radio network node for assisting a wireless device in transmission of a Random Access, RA, message to the radio network node, wherein the radio network node and the wireless device are configured to operate in a wireless communications network, and wherein the radio network node comprises processing circuitry configured to:
detect a preamble transmitted by the wireless device;
determine, based on the detected preamble, that repetitions of transmission of an RA message are to be applied;
transmit, to the wireless device , an indication indicating that repetitions of transmission of the RA message are to be applied; and
receive the message in the RA message transmitted from wireless device in accordance with the indication.

55. The radio network node of claim 54, the processing circuitry further being configured to:
determine, based on the detected preamble, a size of a message to be transmitted from the wireless device to the radio network node; and wherein the radio network node is configured to determine that repetitions of transmission of the RA message are to be applied by further being configured to:
determine a number of repetitions needed for transmission of the RA message based on the determined size of the message.

56. The radio network node of claim 54, wherein the detected preamble is a preamble from at least one out of:
a Random Access preamble Group B; and
a group of contention-free random access preambles.

57. The radio network node of claim 54, wherein the processing circuitry is configured to transmit the indication to the wireless device by further being configured to:
transmit a Random Access Response, RAR, message comprising the indication.

58. The radio network node of claim 57, wherein the RAR message comprises one reserved bit to encode an extra parameter in an uplink grant to enable repetitions of the RA message on a Physical Uplink Synchronization Channel, PUSCH.

59. The radio network node of claim 54, wherein the processing circuitry is configured to transmit the indication to the wireless device by further being configured to:
transmit the indication in a broadcast signaling to the wireless device.

60. The radio network node of claim 54, wherein the RA message is a message Msg3.

61. The radio network node of claim 54, wherein the indication comprises a number of repetitions of the RA message to be made.

62. The radio network node of claim 54, wherein the repetitions of transmission of the RA message are autonomous retransmissions of the RA message.
